(19) United States
(12) Patent Application Publication
(10) Pub. No.: US 2003/0221522 A1
(43) Pub. Date: Dec. 4, 2003

(54) Reversible ratchet wrench

(76) Inventor: Arthur Wu, Taichung Hsien (TW)

Correspondence Address: BACON & THOMAS, PLLC, 625 SLATERS LANE, FOURTH FLOOR, ALEXANDRIA, VA, 22314

(21) Appl. No.: 10/176,675

(22) Filed: Jun. 24, 2002

(30) Foreign Application Priority Data
May 31, 2002 (TW) 91208022

(51) Int. Cl. B25B 13/46

(52) U.S. Cl. 81/63.2

(57) ABSTRACT

A reversible ratchet wrench comprises a handle having a head portion at an end thereof. The head portion has a through hole, a first chamber and a second chamber. An engaging member is received in the through hole of the handle for free rotating. A pawl is received in the first chamber detachably meshed the engaging member. A switching device comprises an axle member and a turning member at an end of the axle member, and a driving device is made from a flexible wire to form a spiral coupling portion and a curved elastic arm projected from an end of the coupling portion. The coupling portion is received in the second chamber and the elastic arm is projected out to rest against the pawl at the driven portion thereof. The axle member of the switching member is inserted into the second chamber via the opening end of the second chamber for driving the elastic arm to turn, and then the pawl is driven to shift by the elastic arm of the driving device.

### FIELD OF THE INVENTION

The present invention related to a hand tool, and more particularly to a reversible ratchet wrench.

### BACKGROUND OF THE INVENTION

U.S. Pat. No. 6,282,992 disclosed a reversible ratchet wrench, please refer to FIG. 14, which comprises a handle 90 having a head portion 91 at an end thereof. The head portion 91 is provided with a through hole 911, a first chamber 912 and a second chamber 913. An engaging member 92 is installed in the through hole 911 for free rotating and is locked by a C-ring 96. A pawl 93 is installed in the first chamber 912 and is detachably meshed with a teeth portion 921 of the engaging member 92. A switching device 94 is installed in the second chamber 913 which has a spring 95 installed in a recess 941 at front side thereof. The distal end of spring 95 rests against the pawl 93 to make it can be driven to shift by turning the switching device 94. A positioning device 97, which is composed of a spring and a ball, is installed in a slot 914 at the rear sidewall of the second chamber 913 to rest against the switching device 94.

To assemble aforesaid reversible ratchet wrench, operator must install the positioning device 97 via the first chamber 912 first, and then insert the switching device 94 via the opening end of the second chamber 913, install the spring 95 to the switching device 94 via the first chamber 912, at least, install the pawl 93 and the engaging member 92 into the first chamber 912 and the through hole 911 in sequence.

It is a hard job to assemble aforesaid ratchet wrench, and more particularly to a ratchet wrench of smaller size.

### SUMMARY OF THE INVENTION

The primary objective of the present invention is to provide a reversible ratchet wrench, which has an easy way to assemble the elements.

According to the objective of the present invention, a reversible ratchet wrench comprises a handle having a head portion at an end thereof. The head portion has a through hole, a first chamber and a second chamber, wherein the first chamber is communicating with the through hole and the second chamber respectively. An engaging member is received in the through hole of the handle for free rotating. A pawl is received in the first chamber detachably meshed with the engaging member. A switching device comprises an axle member having an axial direction and a radial direction and a turning member at an end of the axle member along the axial direction thereof, and a driving device has a coupling portion and an elastic arm, wherein the coupling portion is received in the second chamber and the elastic arm is projected out along the radial direction of the axle member to rest against the pawl at the driven portion thereof. The axle member of the switching is installed in the second chamber to be coupled with the axle member of the turning member along the axial direction thereof.

### BRIEF DESCRIPTION OF THE DRAWINGS

FIG. 1 is an exploded view of a first prefer embodiment of the present invention;

FIG. 2 is a top view of the first prefer embodiment of the present invention in combination;

FIG. 3 is a sectional view along the 3-3 line in FIG. 2;

FIG. 4 is a perspective view of a switching device of the first prefer embodiment of the present invention;

FIG. 5 is a perspective view of a driving device of the first prefer embodiment of the present invention;

FIG. 6 is a top view of the driving device of the first prefer embodiment of the present invention;

FIG. 7 is a sectional view along the 7-7 line in FIG. 6;

FIG. 8 is a sectional view of the first prefer embodiment of the present invention, showing a pawl being moved to left side and the handle being turned counterclockwise;

FIG. 9 is a sectional view following FIG. 8, showing the handle being turned clockwise;

FIG. 10 is a sectional view of the first prefer embodiment of the present invention, showing a pawl being moved to right side and the handle being turned clockwise;

FIG. 11 is a sectional view following FIG. 10, showing the handle being turned counterclockwise;

FIG. 12 is an exploded view of a second prefer embodiment of the present invention;

FIG. 13 is a sectional view of a second prefer embodiment of the present invention, and

FIG. 14 is an exploded view of a conventional reversible ratchet wrench.

### DETAIL DESCRIPTION OF THE INVENTION

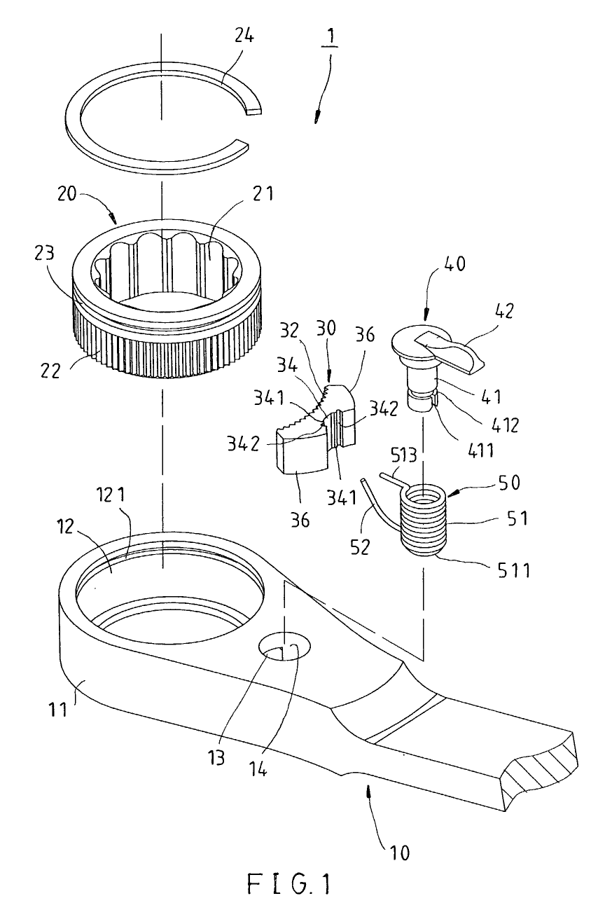

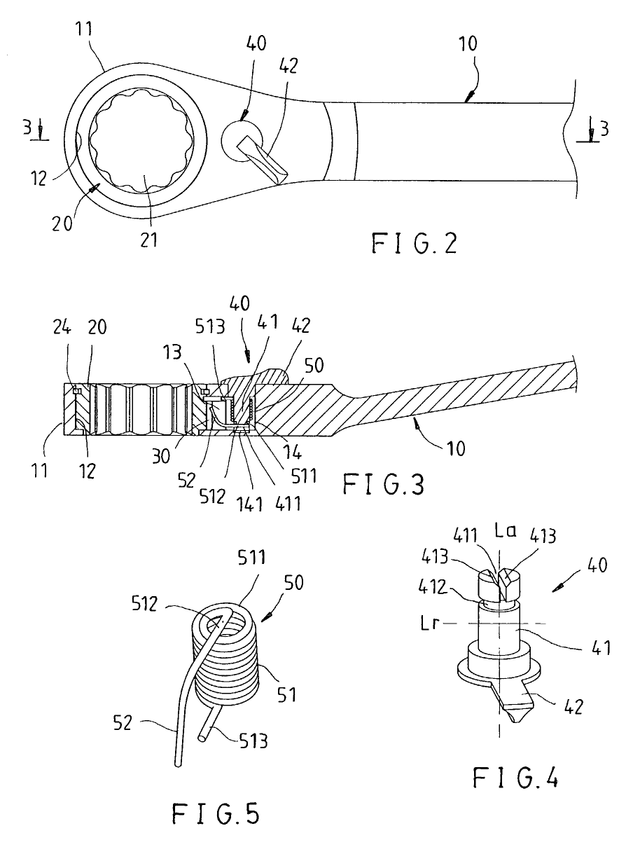

Please refer to FIGS. from FIG. 1 to FIG. 3, a reversible ratchet wrench 1 of the first prefer embodiment of the present invention comprises a handle 10, an engaging member 20, a pawl 30, a switching device 40 and a driving device 50, wherein

The handle 10 has a head portion 11 at an end thereof at which is provided with a through hole 12, a first chamber 13 and a second chamber 13. The first chamber 13 is located between the through hole 12 and the second chamber 14 and is communicated with both of them. The through hole 11 is opening at both sides of the head portion 11 of the handle 10, the first chamber 13 is closed at both sides thereof and the second chamber 14 is opening at a side thereof and is closed at the opposite side thereof. An annular slot 121 is disposed at the sidewall of the through hole 12 and a recess 141 is disposed at the bottom of the second chamber 14.

The engaging member 20 has a dodecahedral hole 21 (or a hexagonal hole) at central for engaging a nut or a bolt (not shown). The engaging member 20 further has a teeth portion 22 at out surface and an annular slot 23 beside the teeth portion 22. The engaging member 20 is received in the through hole 12 of the handle 10 with a retaining ring 24 installed in the annular slots 121 and 23 to lock the engaging member 20 and making it can free rotate.

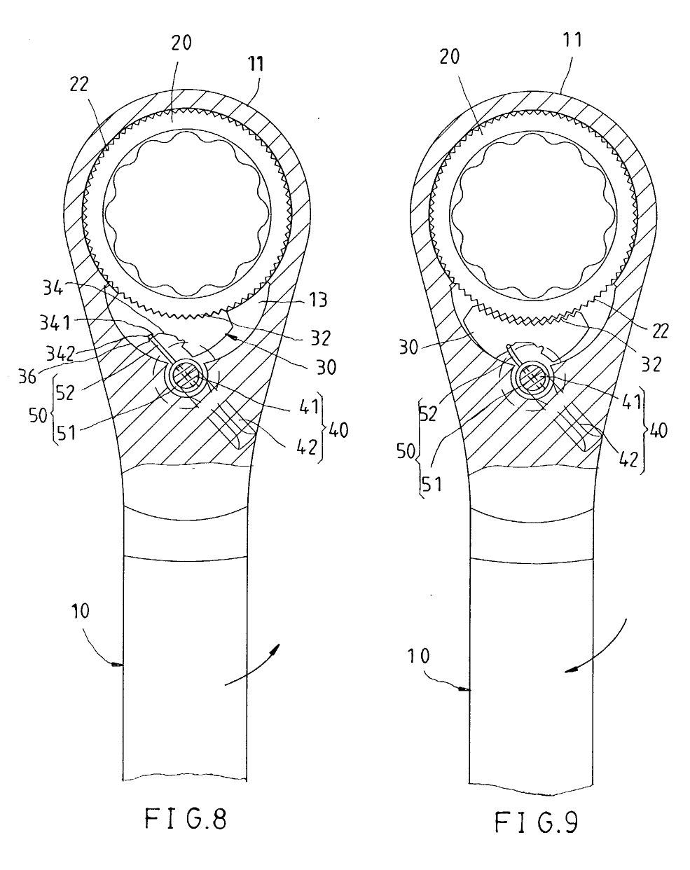

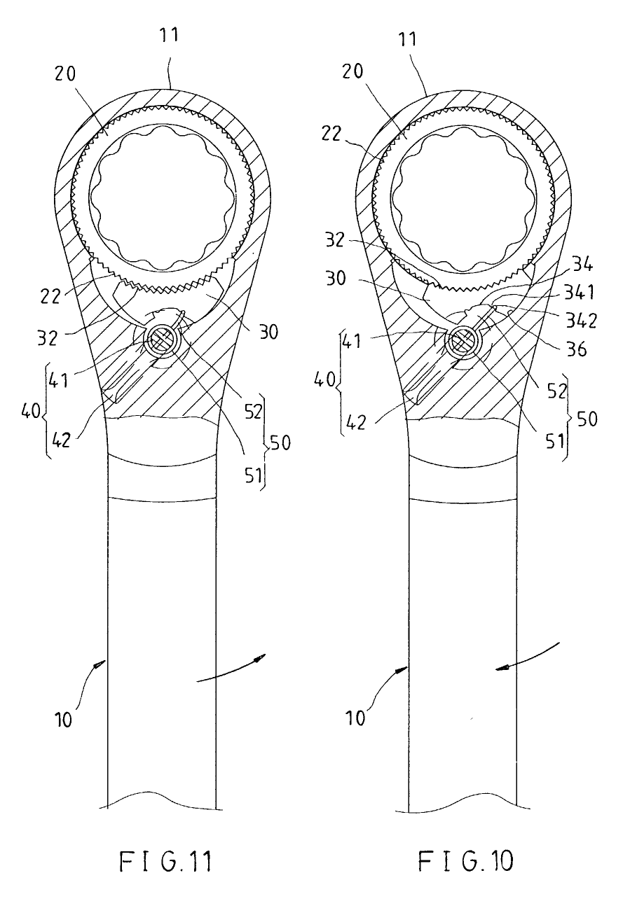

The pawl 30 has a teeth portion 32 at a side thereof, a driven portion 34 at opposite side thereof and two against portions 36 beside the driven portion 34 respectively. The driven portion 34 is a curved cavity in this embodiment having two lug portions 341 and two recesses 342 at two sides thereof, wherein the recesses 342 are located at outsides of the lug portions 341 respectively. The pawl 30 is installed in the first chamber 13 of the handle 10 to be driven to the left side, as shown in FIG. 8, and to the right side, as shown in FIG. 10, of the first chamber 13.

The switching device 40 has an axle member 41 and a turning member 42 at an end of the axle member 41. The axle member 41 is a column in this prefer embodiment having an axial direction La and a radial direction Lr. Please refer to FIG. 4, the axle member 41 has an indentation 411 at the end opposite from the turning member 42 and a locking portion 412 which is an annular recess in this prefer embodiment. Two inclined portions 413 are disposed at the distal end of the axle member 41 at two sides of the indentation 411 respectively. The axle member 41 of the switching device 40 is inserted into the second chamber 14 of the handle 10 via the opening end of the second chamber 14 for the distal end thereof received in the recess 141 and the turning member 42 is left outside to be exerted thereon for driving the axle member 41 to turn.

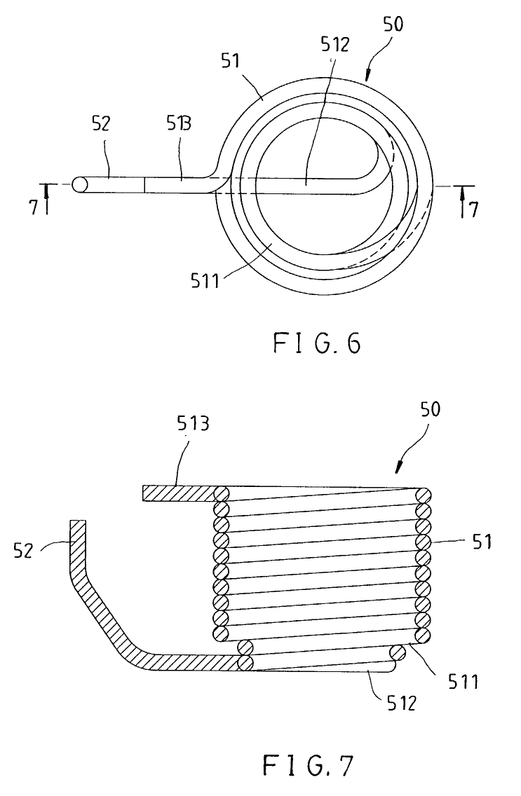

The driving device 50 has a coupling portion 51 and an elastic arm 52. Please refer to FIGS. from FIG. 5 to FIG. 7, the driving device 50 is made from a flexible wire, such as spring wire, so that the coupling portion 51 is a spiral column (like a spring) and the elastic arm 52 is a curved wire projected from an end of the coupling portion 51 along the radial direction thereof. Please refer to FIG. 5, the coupling portion 51 has a locking device 511 which is a smaller diameter section closing to the elastic arm 52, a connecting portion 512 which is a wire section connecting the elastic arm 52 with the coupling portion 51 and crosses the diameter at the end of the coupling portion 51 and a stop portion 513 which is a small wire section projected from the end opposite from the elastic arm 52 along the radial direction.

The coupling portion 51 of the driving device 50 is received in the second chamber 14 of the handle 10 for the stop portion 513 resting against the inner sidewall of the first chamber 13 beside the opening end of the second chamber 14 to prevent the coupling portion 51 from escaping from the second chamber 14 via the opening end thereof. The elastic arm 52 is extended in the first chamber 13 and against the pawl 30 at the driven portion 34. The axle member 41 of the switching device 40 is inserted into the coupling portion 51 of the driving device 50 via the opening end of the second chamber 14, such that the connecting portion 512 of the coupling portion 51 is received in the indentation 411 of the axle member 41 and the locking device 511 of the coupling portion 51 is received in the locking portion 412 of the axle member 41 to lock the coupling member 51 with the axle member 41. Thus, user can turn the turning member 42 of the switching device 40 to drive the elastic arm 52 of the driving member 50 to turn and the pawl 30 will be driven to shift by the elastic arm 52 to the right side and the left side of the first chamber 13.

Please refer to FIG. 8, when turning the turning member 42 of the switching device 40 to right will drive the elastic arm 52 of the driving member 50 turning to left. The elastic arm 52 will cross the lug portion 341 at left side of the driven portion 34 of the pawl 30 first and then is received in the recess 342 behind the lug portion 341, in the meantime, the pawl 30 will be driven to the left side of the first chamber 13 and the against portion 36 at left side thereof will rest against the left sidewall of the first chamber 13.

If user turns the handle 10 counterclockwise, please refer to FIG. 8, the teeth portion 32 of the pawl 30 will be meshed with the teeth portion 22 of the engaging member 20 and make the engaging member 20 turning with the handle 10 for turning loose a nut or a bolt (not shown).

If user turns the handle 10 clockwise, please refer to FIG. 9, the pawl 30 will be detached from the engaging member 20 and the elastic arm 52 will be compressed so that the engaging member 20 will keep still.

On the contrary, please refer to FIG. 10, when turning the turning member 42 of the switching device 40 to left will drive the elastic arm 52 of the driving member 50 turning to right. The elastic arm 52 will cross the lug portion 341 at right side of the driven portion 34 of the pawl 30 first and then is received in the recess 342 behind the lug portion 341, in the meantime, the pawl 30 will be driven to the right side of the first chamber 13 and the against portion 36 at right side will rest against the left sidewall of the first chamber 13.

Please refer to FIG. 10 and FIG. 11, if user turns the handle 10 clockwise will drive a nut or a bolt (not shown) to turn tight but turns the handle 10 counterclockwise will keep the nut or the bolt still.

The operating way of the reversible ratchet wrench 10 of the present invention is as same as a conventional reversible ratchet wrench, so I will not describe the detail here.

One thing I had to mention here is that when the elastic arm 52 is driven to cross the lug portion 341 and be received in the recess 342, there will be a feedback of resistance and sound to user that will make user understanding the elastic arm 52 is turned to the right position.

There will be an easy way to assemble the reversible ratchet wrench 1 of the present invention, first, install the coupling portion 51 of the driving device 50 into the second chamber 14 of the handle 10 via the first chamber 13, and then insert the axle member 41 of the switching device 40 into the coupling portion 51 via the opening end of the second chamber 14. The connecting portion 512 of the coupling portion 51 will be received in the indentation 411 of the axle member 41 and the locking device 511 of the coupling portion 51 will be received in the locking portion 412 of the axle member 41 automatically so that the driving device 50 is secured with the switching device 40 for turning the switching device 40 can drive the elastic arm 52 to turn. At least, install the pawl 30 and the engaging member 20 into the first chamber 13 and the through hole 12 respectively to complete the reversible ratchet wrench 1 of the present invention.

It is obvious to see that the coupling portion 51 of the driving device 50 is coupled with the axle member 41 of the switching device 40 along the axial direction La thereof and the elastic arm 52 is projected out along the radial direction Lr.

The inclined portions 413 on the opposite sides of the indentation 411 are to facilitate the connecting portion 512 of the coupling portion 51 sliding into the indentation 411 when inserting the axle member 41 of the switching device 40 into the coupling portion 51.

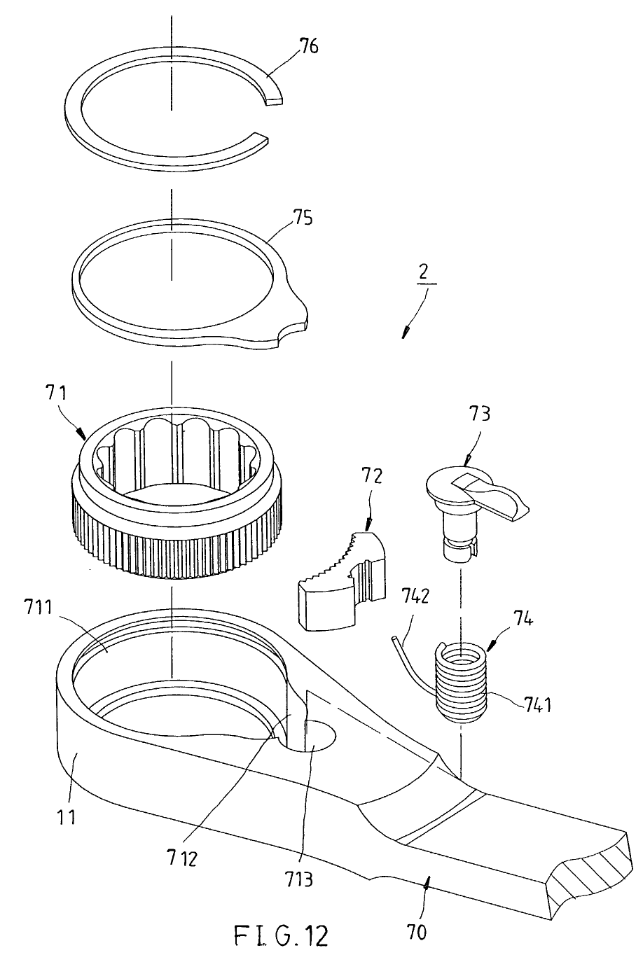

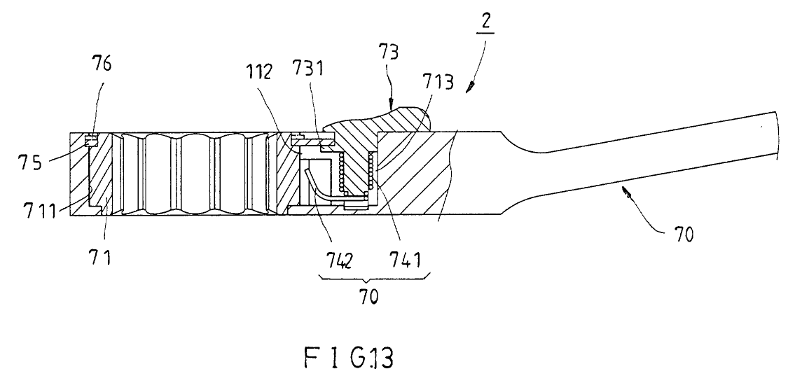

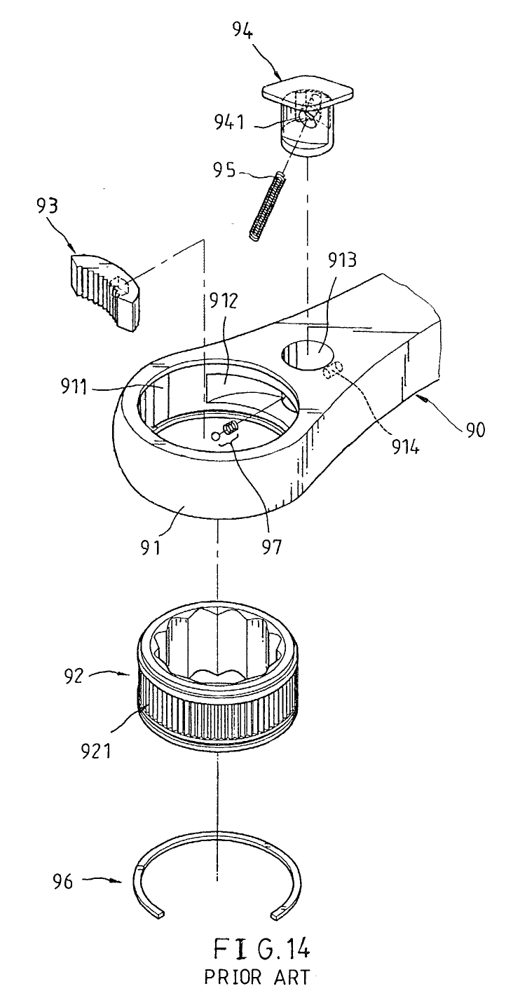

FIG. 12 and FIG. 13 show a reversible ratchet wrench 2 of the second prefer embodiment of the present invention, it is similar to the first prefer embodiment, comprising a handle 70, an engaging member 71, a pawl 72, a switching device 73 and a driving device 74. The handle 70 has a through hole 711, a first chamber 712 and a second chamber 713, wherein the through hole 711 is opening at both sides of the handle 711 and the first and the second chambers 712 and 713 are opening at a side of the handle 70. A cover 75 is installed on the handle 10 at the opening ends of the through hole 711 and the first chamber 712. A retaining ring 76 is applied to lock the cover 75. The switching device 73 has a lug 731 below the cover 75 to prevent it from escaping from the second chamber 713. The driving device 74 has a coupling portion 741 and an elastic arm 742 but without aforesaid stop portion.

What is claimed is:

1. A reversible ratchet wrench, comprising:
a handle having a head portion at an end thereof; said head portion having a through hole, a first chamber and a second chamber, wherein said through hole is opening at both sides of said handle, said second chamber is opening at a side of said handle and said first chamber is communicating with said through hole and said second chamber respectively;
an engaging member received in said through hole of said handle for free rotating; said engaging member having a polygonal hole at central and a teeth portion at out surface thereof;
a pawl having a teeth portion at a side thereof and a driven portion at the other side thereof; said pawl received in said first chamber of said handle with said teeth portion thereof detachably meshed with said teeth portion of said engaging member;
a switching device comprising an axle member having an axial direction and a radial direction and a turning member at an end of said axle along the axial direction thereof; said axle member installed in said second chamber and said turning member left out of said second chamber for turning said turning member can drive said axle member rotating along the axial direction thereof, and
a driving device having a coupling portion and an elastic arm, wherein said coupling portion is received in said second chamber and is coupled with said axle member of said turning member along the axial direction of said axle member and said elastic arm is projected out along the radial direction of said axle member to rest against said pawl at said driven portion thereof.

2. The reversible ratchet wrench as defined in claim 1, wherein said driving device is made from a flexible wire to form said coupling portion as a spiral section and said elastic arm as a curved section which projects from an end of said coupling portion.

3. The reversible ratchet wrench as defined in claim 2, wherein said axle member of said switching is inserted into said coupling portion of said driving device via the opening end of said second chamber.

4. The reversible ratchet wrench as defined in claim 1, wherein said axle member of said switching member has an indentation at the distal end thereof and said coupling portion of said driving member has a connecting portion, which connects said coupling portion with said elastic arm, received in said indentation.

5. The reversible ratchet wrench as defined in claim 1, wherein said axle member of said switching member has a locking device and said coupling portion of said driving member has a locking portion such that said locking device is locked with said locking portion to secure said axle member with said coupling portion.

6. The reversible ratchet wrench as defined in claim 4, wherein said axle member of said switching member has at least an inclined portion at the opening end of said indentation.

7. The reversible ratchet wrench as defined in claim 1, wherein said coupling portion of said driving member has a stop portion resting against the sidewall of said first chamber.

8. The reversible ratchet wrench as defined in claim 1, wherein said pawl has two lug portions at said driven portion.

9. The reversible ratchet wrench as defined in claim 1, wherein said pawl has two recesses at said driven portion.

10. The reversible ratchet wrench as defined in claim 1, wherein said driven portion of said pawl is a curved cavity provided with two lug portions thereon and two recesses at outer sides of said lug portions respectively.

11. The reversible ratchet wrench as defined in claim 1, wherein said first chamber of said handle is opening at a side of said handle and said axle member of said switching device has a lug, whereby a cover is fixed on said handle covering the opening end of said first chamber and said lug of said switching device is below said cover.
